(19) United States
(12) Patent Application Publication
(10) Pub. No.: US 2012/0062626 A1
(43) Pub. Date: Mar. 15, 2012

(54) RECORDING TIMING ADJUSTMENT APPARATUS OF RECORDING APPARATUS, RECORDING APPARATUS, AND RECORDING TIMING ADJUSTMENT METHOD OF RECORDING APPARATUS

(75) Inventors: Toshiaki ISHIKAWA, Matsumoto-shi (JP); Masato MITSUHASHI, Hara-mura (JP); Tomohiro YUDA, Minowa-machi (JP)

(73) Assignee: SEIKO EPSON CORPORATION, Tokyo (JP)

(21) Appl. No.: 13/229,238

(22) Filed: Sep. 9, 2011

(30) Foreign Application Priority Data
Sep. 10, 2010 (JP) 2010-202778

(51) Int. Cl. B41J 29/38

(52) U.S. Cl. 347/5

(57) ABSTRACT

A plurality of recording heads are individually assembled in a carriage in a serial type printer. A plurality of sets of patterns are printed at a plurality of sets of print timings while changing deviations of print timings of the recording heads. A numerical value corresponding to an optimally printed pattern with a small deviation among the plurality of sets of patterns is input. A control unit sets print timing corresponding to the input value.

### BACKGROUND

1. Technical Field

The entire disclosure of Japanese Patent Application No. 2010-202778, filed Sep. 10, 2010 is expressly incorporated by reference herein.

The present invention relates to a recording timing adjustment apparatus of a recording apparatus having a recording timing adjustment function of a plurality of recording units, a recording apparatus, and a recording timing adjustment method of the recording apparatus.

2. Related Art

For example, JP-A-5-254121 discloses a technique of solving a problem, in an electro-static control type ink jet recording apparatus, that the distance between adjacent heads varies depending on the accuracy with which the heads are fixed and the dots overlap while being shifted. That is, the position of an air discharge opening provided in each recording head is measured so as to adjust ink discharge timing.

However, this technique is limited to the structure of the electro-static control type ink jet recording apparatus and cannot be used for general purposes. In addition, since the position of the air discharge opening provided in each recording head is measured so as to adjust the ink discharge timing, it is not possible to adjust a deviation in landing positions of the ink due to a variation in the state (height, slope, or the like) in which the recording head is fixed.

### SUMMARY

An advantage of some aspects of the invention is that it provides a recording timing adjustment apparatus of a recording apparatus capable of adjusting a variation in recording position due to a variation in positions of a plurality of recording units to be relatively simply small and suppressing deterioration in recording quality due to the variation in positions of the recording units, a recording apparatus, and a recording timing adjustment method of the recording apparatus.

According to an aspect of the invention, there is provided a recording timing adjustment apparatus of a recording apparatus in which a plurality of recording units records a plurality of subpixels configuring a recording pixel while relatively moving the plurality of recording units and a recording medium so as to perform recording with respect to the recording medium, the recording timing adjustment apparatus including: a relative movement unit that relatively moves the plurality of recording units and the recording medium; an instruction unit that individually adjusts recording timings of the plurality of recording units and instructs a plurality of sets of recording timings with different deviations in recording timing between the plurality of recording units; a recording execution unit that enables the plurality of recording units to perform recording at the plurality of sets of recording timings instructed by the instruction unit; and an adjustment unit that sets one set of recording timings based on plural kinds of recording results according to the plurality of sets of recording timings when the recording execution unit enables the plurality of recording units to perform recording.

According to the aspect of the invention, through the instruction unit, the recording timings of the plurality of recording units is individually adjusted and the plurality of sets of recording timings with different deviations in recording timing between the plurality of recording units is instructed. The recording execution unit enables the plurality of recording units to perform recording at the plurality of sets of recording timings instructed by the instruction unit. As a result, the plural kinds of recording results according to the plurality of sets of recording timings are obtained in the recording medium. Through the adjustment unit, one set of recording timings is set based on plural kinds of recording results. Accordingly, it is possible to relatively simply adjust a variation in recording position due to a variation in position between the plurality of recording units in the relative movement directions and suppress deterioration in recording quality due to a variation in position between the recording units.

In the recording timing adjustment apparatus according to the aspect of the invention, the plurality of recording units may be assembled in a carriage moved by the relative movement unit at positions different from the relative movement direction.

According to the aspect of the invention, in the serial type recording apparatus in which the plurality of recording units is individually assembled in the carriage, it is possible to set adequate recording timings considering a variation in the assembling position of the plurality of recording units relative to the carriage.

In the recording timing adjustment apparatus according to the aspect of the invention, the instruction unit may instruct the recording timings of the other recording units to be different from the recording timing of one recording unit by degrees, and the recording execution unit may enable the plurality of recording units to respectively record a pattern.

According to the aspect of the invention, through the instruction unit, the recording timings of the other recording units are instructed to be different from the recording timing of one recording unit by degrees. Since the recording timing of one recording unit is constant and the recording timings of the other recording units deviate therefrom with different deviations by degrees, it is possible to relatively simply perform instruction through the instruction unit.

In the recording timing adjustment apparatus according to the aspect of the invention, the recording execution unit may record a plurality of sets of patterns in which a pattern recorded by one of the plurality of recording units and a pattern recorded by another recording unit are adjacently arranged in a relative movement direction.

According to the aspect of the invention, the recording execution unit records the plurality of sets of patterns in which the pattern recorded by one of the plurality of recording units and the pattern recorded by another recording unit are adjacently arranged in the relative movement direction. Accordingly, it is easy to determine the recording result corresponding to the deviation of the optimal recording timing of the plural kinds of recording results. As a result, it is possible to set the optimal recording timing.

In the recording timing adjustment apparatus according to the aspect of the invention, the adjustment unit may receive an input value corresponding to a recording result of one of the plural kinds of recording results based on an operation of an operation unit and set the recording timings based on the input value.

According to the aspect of the invention, the user observes the plural kinds of recording result and inputs the input value corresponding to the optimal recording result by the operation of the operation unit. The adjustment unit sets the recording timings of the plurality of recording units based on the input value received by the operation of the operation unit. Since the recording timing of the optimal recording result observed and determined by the user is set, the user may obtain preferable recording quality. It is possible to provide a recording timing adjustment apparatus having a relatively simple configuration without providing a relatively complicated processing device such as an image analyzer.

In the recording timing adjustment apparatus according to the aspect of the invention, a reading unit that reads the plural kinds of recording results recorded by the plurality of recording units and an image analysis unit that analyzes an image read by the reading unit and obtains a recording result with a minimum deviation in the relative movement direction may be further included, and the adjustment unit may set the recording timing corresponding to the recording result obtained by the image analysis unit.

According to the aspect of the invention, the plural kinds of recording results recorded by the plurality of recording units are read by the reading unit. The image analysis unit analyzes the read image and obtains the recording result with a minimum deviation in the relative movement direction. The adjustment unit sets the recording timing corresponding to the recording result obtained by the image analysis unit. Accordingly, it is possible to automatically set the optimal recording timing of the plurality of recording units.

In the recording timing adjustment apparatus according to the aspect of the invention, one relative movement may be performed at a recording timing of one deviation and a plurality of relative movements may be performed with deviations different from the deviation of one relative movement so as to record the plurality of sets of patterns, and the recording execution unit may record the plurality of sets of patterns with different deviations in recording timing in one relative movement based on image data in which a recording position of the pattern deviates in units of the pixel pitch of the recording pixel in the relative movement direction.

According to the aspect of the invention, one relative movement is performed at the recording timing of one deviation and a plurality of relative movements is performed with deviations different from the deviation of one relative movement so as to record the plurality of sets of patterns. At this time, the recording execution unit records the plurality of sets of patterns with different deviation in recording timing in one relative movement based on image data in which the recording position of the pattern deviates in units of the pixel pitch of the recording pixel in the relative movement direction. Accordingly, it is possible to relatively reduce the number of times of relative movement of the plurality of recording units and obtain the plural kinds of recording results within a relative short period of time.

In the recording timing adjustment apparatus according to the aspect of the invention, the recording execution unit may enable the plurality of recording units to perform recording of a forward movement process in the relative movement direction and to perform recording of a backward movement process in the relative movement direction.

According to the aspect of the invention, the recording execution unit enables the plurality of recording units to perform recording of a forward movement process in the relative movement direction and to perform recording of a backward movement process in the relative movement direction. It is possible to set adequate recording timing in both the forward movement process and the backward movement process of the plurality of recording units.

In the recording timing adjustment apparatus according to the aspect of the invention, the deviations of the recording timing of the forward movement process and the recording timings of the backward movement process of at least one of the plurality of recording units may be changed by degrees so as to perform a second recording, and the adjustment unit may set the recording timings of the plurality of recording units based on the deviations in the recording timings of the forward movement process and the backward movement process of the recording unit determined based on the second recording result of the second recording and the deviation in the recording timing between the plurality of recording units.

According to the aspect of the invention, the deviations of the recording timing of the forward movement process and the recording timings of the backward movement process of at least one of the plurality of recording units are changed by degrees so as to perform a second recording. The adjustment unit sets the recording timings of the plurality of recording units based on the deviations in the recording timings of the forward movement process and the backward movement process of at least one of the recording units determined based on the second recording result of the second recording and the deviation in the recording timing between the plurality of recording units. As a result, it is possible to decrease the deviation in the recording timings of the plurality of recording units due to a variation in position and decrease the deviation in the recording timings of the forward movement process and the backward movement process.

According to another aspect of the invention, there is provided a recording apparatus including a plurality of recording units and a relative movement unit that relatively moves the plurality of recording units and a recording medium, including the recording timing adjustment apparatus according to the aspect of the invention. According to the aspect of the invention, since the recording timing adjustment apparatus according to one of the aspects of the invention is included, it is possible to obtain one of the effects of the aspects of the invention according to the data storage processing apparatus.

According to still another aspect of the invention, there is provided a recording timing adjustment method of a recording apparatus in which a plurality of recording units records a plurality of subpixels configuring a recording pixel while relatively moving the plurality of recording units and a recording medium so as to perform recording with respect to the recording medium, the recording timing adjustment method including: relatively moving the plurality of recording units and the recording medium and performing recording at a plurality of sets of recording timings with different deviations in recording timing between the plurality of recording units; setting one set of recording timings based on plural kinds of recording results obtained as the result of recording. According to the aspect of the invention, it is possible to obtain the same effects as the recording timing adjustment apparatus according to one of the aspects of the invention.

### BRIEF DESCRIPTION OF THE DRAWINGS

The invention will be described with reference to the accompanying drawings, wherein like numbers reference like elements.

FIG. 1 is a schematic side view of a printer according to a first embodiment.

FIG. 2 is a schematic bottom view of a carriage.

FIG. 3 is a block diagram showing the configuration of a printer.

FIG. 4 is a block diagram showing the electrical configuration of a print timing signal generation circuit.

FIGS. 5A and 5B are schematic views showing a portion of an adjustment chart.

FIG. 6A is a schematic diagram showing a reference pattern.

FIG. 6B is a schematic diagram showing a relative pattern.

FIGS. 7A to 7C are schematic diagrams showing a relative positional relationship between a reference pattern and a relative pattern.

FIGS. 8A to 8D are schematic side views illustrating print (ejection) timing of a pattern.

FIG. 9 is a schematic side view illustrating Bi-d adjustment (bidirectional adjustment).

FIG. 10 is a schematic diagram illustrating a print order of a chart.

FIG. 11 is a schematic diagram illustrating a print pixel.

FIG. 12 is a flowchart illustrating a print timing adjustment process.

FIG. 13 is a flowchart illustrating a chart print processing routine.

FIG. 14A is a block diagram showing a printer and a scanner.

FIG. 14B is a schematic perspective view of a printer to which is attached a reading sensor.

FIG. 15 is a flowchart illustrating a print timing adjustment process.

FIG. 16 is a schematic plan view showing a line printer.

FIG. 17 is a schematic diagram showing a line recording type recording head and controller.

FIG. 18 is a schematic bottom view showing a plurality of recording heads according to a modified example.

FIG. 19 is a schematic bottom view showing a carriage according to a modified example different from FIG. 18.

### DESCRIPTION OF EXEMPLARY EMBODIMENTS

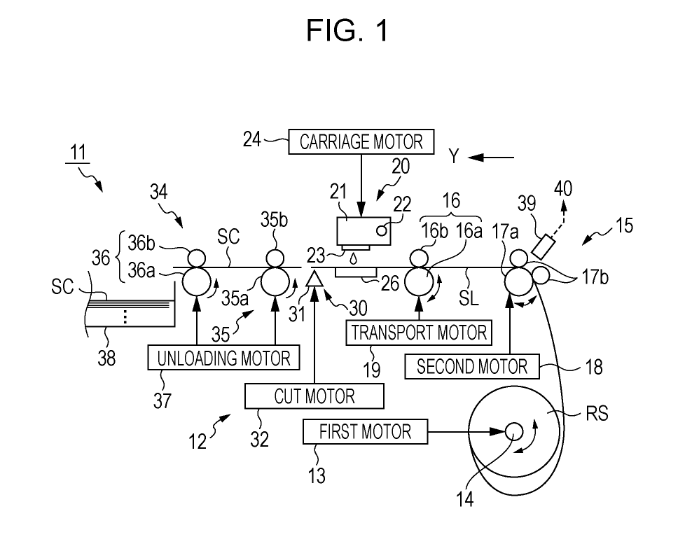

Hereinafter, an ink jet printer according to an embodiment of the invention will be described with reference to FIGS. 1 to 13.

As shown in FIG. 1, a printer 11 which is an example of a recording apparatus of the present embodiment is a serial type ink jet printer. The printer 11 includes a transport device 12 for delivering and transporting an elongated sheet SL by degrees from a roll RS on which the elongated sheet SL is wound as an example of a recording medium.

A shaft member 14 is rotated and driven by a first motor 13 in a predetermined direction such that the sheet SL is delivered from the roll RS along a transport path. The transport device 12 includes a delivery unit 15 for delivering the elongated sheet SL from the roll RS by degrees and a pair of transport rollers 16 disposed on a transport direction downstream side of the delivery unit 15. The delivery unit 15 delivers the elongated sheet SL to the transport direction downstream side by driving a second motor 18 so as to rotate a delivery roller 17a and rotate a driven roller 17b.

The pair of transport rollers 16 transports the elongated sheet SL to the transport direction downstream side by driving a transport motor 19 so as to rotate the transport roller 16a and rotate a driven roller 16b.

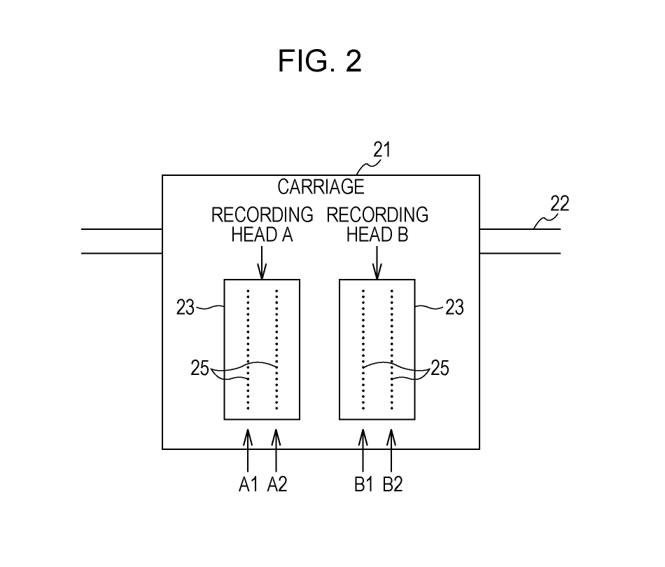

At a midway position of a transport direction Y (also referred to as a “sub scanning direction”) of the elongated sheet SL, a recording unit 20 is provided as an example of recording unit for performing recording with respect to the elongated sheet SL. In this recording unit 20, a carriage 21 is guided by a guide shaft 22 so as to be reciprocally moved in a main scanning direction X. The carriage 21 has a plurality of recording heads as an example of a plurality of recording units at a portion facing the sheet SL. An ink which is an example of a fluid is supplied from an ink cartridge (not shown) detachably mounted in the printer 11 to the recording head 23. The carriage 21 is reciprocally moved in the main scanning direction X by rotating normally and reversely a carriage motor 24 and ink droplets are ejected from nozzles 25 (see FIG. 2) toward a surface (upper surface in FIG. 1) of the elongated sheet SL by driving a driving element in the recording head 23 while movement.

By appropriately alternately performing a print operation of one row performed by moving the recording head 23 one time (one pass) in the main scanning direction X along with the carriage 21 and a transport operation by the transport device 12 for transporting the sheet SL to a recording position of a next row, printing is performed on the surface of the sheet SL. In the present embodiment, a print image such as a photo is printed on the sheet SL. At a position facing the recording head 23 with the sheet SL interposed therebetween, a support member 26 supporting the sheet SL is provided to be extend along the width direction (main scanning direction X) of the sheet.

At a position (cut position) of the transport direction downstream side (the left side in FIG. 1) of the recording unit 20, a cutter 31 of a cutting unit 30 is moved in the width direction (main scanning direction X) of the sheet SL by driving force from a cut motor 32 such that a recorded portion is separated from the elongated sheet SL. On the transport direction downstream side of the cut unit 30, a discharging unit 34 for discharging the cut sheet SC separated from the elongated sheet SL to the transport direction most downstream side is provided.

The discharging unit 34 includes a plurality (2 in the present embodiment) of pairs of discharging rollers 35 and 36 arranged along the transport direction Y. When the discharging motor 37 is driven, the rollers 35a and 35b and the rollers 36a and 36b are rotated while the recorded cut sheet SC is interposed between two positions along the transport direction, and the cut sheet SC is discharged to the transport direction downstream side and is received in a discharging tray 38 in a stack state. At an upstream position in the transport direction Y of one pair of transport rollers 16, a detection sensor 39 for detecting a front end of the elongated sheet SL is provided. The detection signal from the detection sensor 39 is output to a controller 40 for controlling the printer 11 and is used for transport position control of the sheet SL.

FIG. 2 is a schematic diagram of the bottom of the carriage. As shown in FIG. 2, two recording heads 23 are assembled in the bottom of the carriage at two predetermined positions along the main scanning direction X. Since print resolution of this kind of printer 11 is considerably high, a gap between dots formed by ink droplets ejected from the nozzles 25 is very small. Thus, a plurality of recording heads 23 needs to be assembled with high position accuracy in the main scanning direction X. However, it is difficult to assemble the recording heads with assembling position accuracy capable of ensuring the necessary print accuracy due to a variation in the fixing position. Each recording head 23 has two nozzle arrays including a plurality (for example, 180) of nozzles 25 arranged with a predetermined nozzle pitch along the sub scanning direction Y.

In the present embodiment, a plurality (two, in this example) of recording heads 23 arranged along the main scanning directions X may be referred to as recording heads A and B. The two nozzle arrays of the recording head A are respectively referred to as nozzle arrays A1 and A2 and the two nozzle arrays of the recording head B are respectively referred to as nozzle arrays B1 and B2.

As shown in FIG. 2, the nozzle arrays A1 and A2 are formed on the recording head A and the nozzle arrays B1 and B2 are formed on the recording head B. A variation in processing accuracy when the nozzle arrays are formed in the recording head 23 is extremely small so as to be negligible as compared to a variation in the assembling positions when the recording heads A and B are assembled in the carriage 21. Thus, both a variation in gap between both nozzle arrays Al and A2 in the main scanning direction X and a variation in gap between both nozzle arrays B1 and B2 in the main scanning direction X may be substantially neglected. In contrast, a variation in gap between the nozzle array Al and the nozzle array B1 in the main scanning direction X and a variation in gap between the nozzle array A2 and the nozzle array B2 in the main scanning direction X depend on a variation in the assembling positions of the recording heads A and B in the main scanning direction X. This variation in gap depends on the variation in the assembling positions of the recording heads A and B, is relatively large, and is not negligible in terms of print accuracy. Thus, in the present embodiment, ejecting timing of each nozzle array is corrected such that printing is performed with the desired print quality even when the variation in the assembling position of this kind of recording head is present, thereby solving or reducing a deviation in ejection timing due to a variation in the assembling position. In the present example, it is possible to adjust the ejection timing of each of the recording heads A and B.

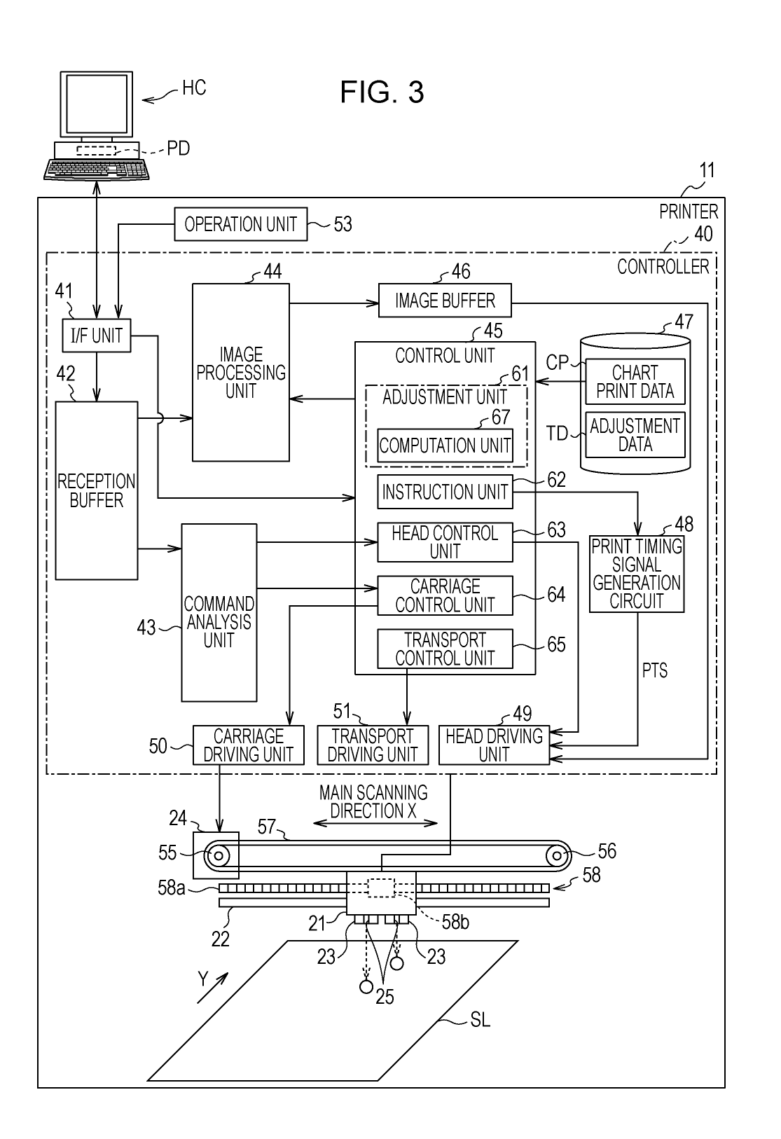

Next, the electrical configuration of the printer 11 will be described. FIG. 3 is a schematic diagram showing the internal configuration of the printer 11. In FIG. 3, the transport device 12 and a driving control system thereof are omitted.

As shown in FIG. 3, the printer 11 includes a controller 40 therein. The controller 40 receives print data from a printer driver PD of a host device HC via an interface (hereinafter referred to as an I/F 41).

The controller 40 has a CPU, an Application Specific IC (ASIC; special-purpose IC), a ROM, a non-volatile memory and a RAM. The ROM stores various control systems, a variety of data, and the like. The non-volatile memory stores various programs including a firmware program and a variety of data necessary for a print process. The RAM temporarily stores a computation result or the like of the CPU and is used as a buffer for storing print data received from the host device HC and data while processing print data and after processing.

The controller 40 includes a reception buffer 42, a command analysis unit 43, an image processing unit 44, a control unit 45, an image buffer 46, a non-volatile memory 47, a print timing signal generation circuit 48, a head driving unit 49, a carriage driving unit 50, a transport control unit 51, and the like, in addition to the I/F 41. In the printer 11, an operation unit 53 is provided as an example of an operation unit for enabling a user to perform an input operation and an input value by the operation of the operation unit 53 is input to the control unit 45 via the I/F 41. The command analysis unit 43, the image processing unit 44 and the control unit 45 are realized by at least one CPU (software) for executing a control program stored in the ROM and an ASIC (hardware). The units 43 to 45 may be established by cooperation of software and hardware, only software or only hardware. The reception buffer 42 and the image buffer 46 are constructed by a RAM.

As shown in FIG. 3, the carriage 21 is fixed with a portion of a timing belt 57 wound on a driving pulley 55 connected to a driving shaft of the carriage motor 24 and a driven pulley 56. By rotating normally and reversely the carriage motor 24, the carriage 21 is reciprocally moved via the timing belt 57 performing normal/reverse rotation in the main scanning direction X. A linear encoder 58 for detecting the movement position (carriage position) of the carriage 21 is provided at a position of a rear surface side of the movement path of the carriage 21.

As shown in FIG. 3, the linear encoder 58 includes a code plate 58a of a tape shape in which a plurality of slits is formed with a constant pitch (for example, 1/180 inches (= 1/180×2.54 cm) and a sensor 58b having a light emitting element and a light receiving element provided in the carriage 21. The light receiving element receives light emitted from the light emitting element and transmitting through code slits when the carriage 21 is moved such that the sensor 58b outputs a detection pulse. The controller 40 includes a CR position counter (not shown) for counting, for example, pulse edges of detection pulses (two pulses having an A phase and a B phase, in which the phase is shifted by 90 degrees) received from the linear encoder 58. The count value of the CR position counter increases when the carriage is moved to the opposite side of the home position and decreases when the carriage is moved to the home position so as to recognize the position of the carriage 21 using the home position HP as an original point.

The printer driver PD performs a known color conversion process, resolution conversion process, halftone process, and rasterization process with respect to image data of a color coordinate system (for example, a RGB color coordinate system) for monitor display so as to generate print data.

A control command described in a header is created based on print condition data and print image data and includes a variety of commands such as a transport system command such as a paper feed operation, a paper conveying operation and a paper discharge operation or a print system command such as a carriage operation and a recording head operation (recording operation). In this example, if one of a plurality of print modes is selected as one print condition, “bidirectional print” or “unidirectional print” is selected according to the selected print mode.

The reception buffer 42 shown in FIG. 1 is a memory region (storage region) for temporarily storing print data received via the I/F 41.

The command analysis unit 43 reads a header of print data from the reception buffer 42, acquires a control command or the like therefrom, and analyzes the control command described in a printer description language. The command analysis result is sent to a head control unit 63, a carriage control unit 64 and a transport control unit 65 of the control unit 45.

The image processing unit 44 reads print image data in the print data from the reception buffer 42 by a single line (main scanning line), performs predetermined image processing, and stores head image data after image processing in the image buffer 46.

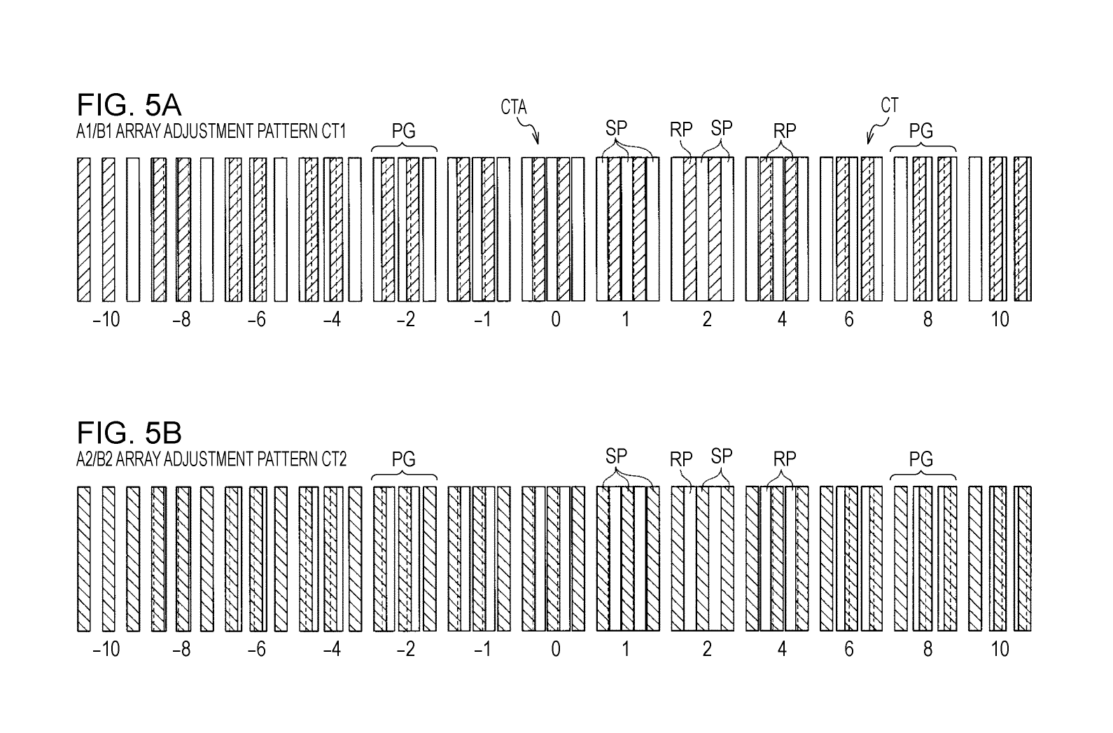

The control unit 45 includes an adjustment unit 61, an instruction unit 62, a head control unit 63, a carriage control unit 64 and a transport control unit 65. The instruction unit 62 individually adjusts ejection timing of each recording head 23 and changes a combination of ejection timings of each recording head 23 by degrees so as to perform chart print processing for printing an adjustment chart CT (see FIGS. 5A and 5B).

The non-volatile memory 47 stores chart print data CP and adjustment data TD. The chart print data CP is print data for printing the adjustment chart CT shown in FIGS. 5A and 5B.

A user views an adjustment chart printed on a sheet SL and operates the operation unit 53 to input a numerical value (adjustment value) corresponding to an optimal pattern suiting the ejection timing of each recording head 23. The adjustment data TD is data in which, when the user who views a print result of the adjustment chart CT inputs a numerical value corresponding to an optimal pattern printed at optimal print ejection timing, an adjustment value for determining optimal ejection timing is set based on the input numerical value.

The adjustment unit 61 acquires the adjustment value of ejection timing based on the numerical value received from the operation unit 53. The adjustment unit 61 has a computation unit 67 for performing various computations necessary to determine ejection timing.

The carriage control unit 64 recognizes a movement direction of the carriage 21 based on a phase difference between encoder pulse signals having two phases, that is, the A phase and the B phase, received from the linear encoder 58. The carriage control unit 64 detects the movement position from an original point position (for example, the home position) of the carriage 21 by increasing the carriage counter upon forward movement and decreasing the carriage counter upon backward movement whenever the edge of the encoder pulse signal is detected. The position of the carriage 21 in the main scanning direction X is used to control the speed of the carriage motor 24.

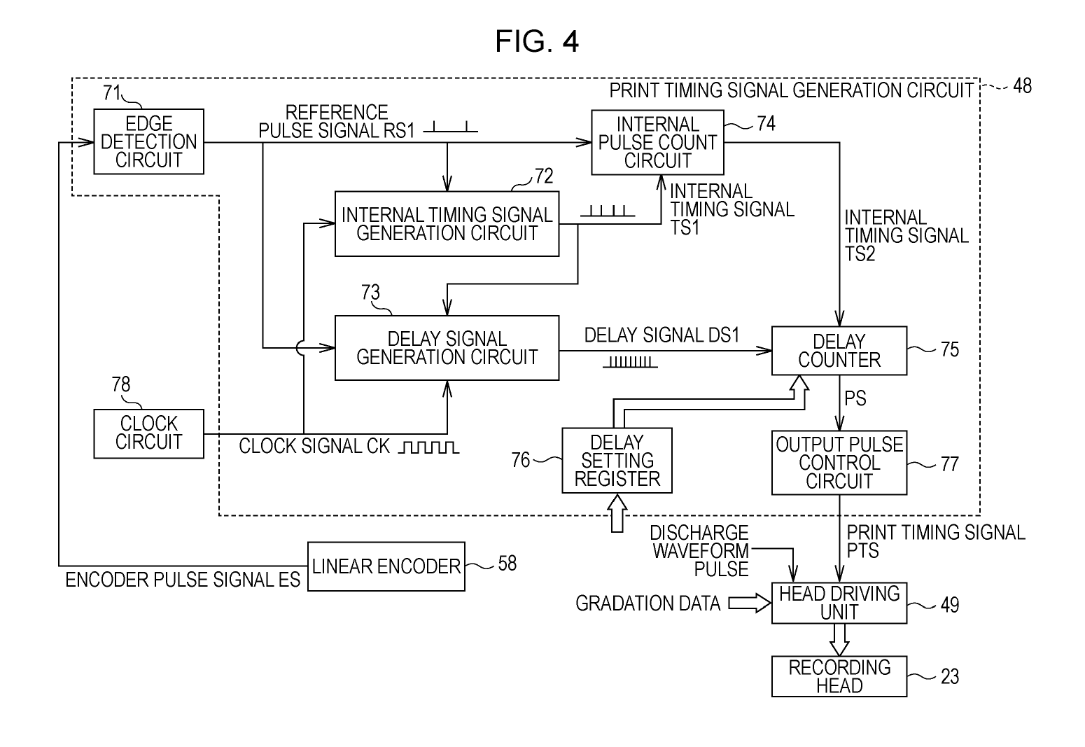

Next, the configuration of the print timing signal generation circuit 48 will be described. FIG. 4 is a block diagram showing the configuration of the print timing signal generation circuit. The print timing signal generation circuit 48 is, for example, provided in an ASIC and is a circuit for generating a print timing signal PTS based on an encoder pulse signal received from the linear encoder 58.

As shown in FIG. 4, the print timing signal generation circuit 48 includes an edge detection circuit 71 for inputting an encoder pulse signal from the linear encoder 58, an internal timing signal generation circuit 72, a delay signal generation circuit 73, an internal pulse count circuit 74, a delay counter 75, a delay setting value register 76, and an output pulse control circuit 77.

The edge detection circuit 71 generates a pulse whenever a rising edge of an encoder pulse signal received from the sensor 58b of the linear encoder 58 is detected, thereby generating a reference pulse signal RS1. The reference pulse signal RS1 is input to the internal timing signal generation circuit 72, the delay signal generation circuit 73 and the internal pulse count circuit 74.

A signal generation process performed by the print timing signal generation circuit 48 includes a period division process (multiplying process) of dividing (multiplying) the period of the reference pulse signal RS1 and generating pulses of a plurality of periods divided from one period and a delay process of delaying the pulse signals obtained by the period division process by only a delay time determined according to the movement speed and the movement direction (a difference between forward movement and backward movement) of the carriage 21 and the like and generating a print timing signal.

The internal timing signal generation circuit 72 receives the reference pulse signal RS1 from the edge detection circuit 71 and receives a clock signal CK from a clock circuit 78. The internal timing signal generation circuit 72 performs the period division process of dividing the period of the reference pulse signal RS1 into 16 portions and generates an internal timing signal TS1 having pulses of a period ( 1/16). The internal timing signal generation circuit 72 outputs the generated internal timing signal TS1 to the delay signal generation circuit 73 and the internal pulse count circuit 74.

The delay signal generation circuit 73 receives the reference pulse signal RS1 from the edge detection circuit 71, receives the clock signal CK from the clock circuit 78, and receives the internal timing signal TS1 from the internal timing signal generation circuit 72. The delay signal generation circuit 73 performs a period division process of dividing the period of the reference pulse signal RS1 and generates a delay signal DS1 having pulses of a 1/128 period of the period of the internal timing signal TS1. The delay signal generation circuit 73 outputs the generated delay signal DS1 to the delay counter 75.

The internal pulse count circuit 74 receives the reference pulse signal RS1 from the edge detection circuit 71 and receives the internal timing signal TS1 from the internal timing signal generation circuit 72. The internal pulse count circuit 74 counts the pulses of the internal timing signal TS1 and outputs a new internal timing signal TS2 in which pulses are generated whenever the count result becomes “15” and when the pulses of the reference pulse signal RS1 are received. The internal pulse count circuit 74 outputs a first pulse of the internal timing signal TS2 of a next period when being reset by the pulse input of the reference pulse signal RS1. Then, the internal pulse count circuit 74 outputs the internal timing signal TS2 in which 16 pulses are included in one period of the reference pulse signal RS1. The internal timing signal TS2 is used as a reference signal for determining ejection timing (driving timing) when ink droplets are ejected and is output to the delay counter 75.

The delay counter 75 receives the internal timing signal (reference signal) TS2 from the internal pulse count circuit 74 and receives the delay signal DS1 from the delay signal generation circuit 73. Such a delay counter 75 has a function for delaying the internal timing signal TS2 by only a delay time based on the delay setting value Dc stored in the delay setting value register 76 and outputting the delayed signal.

The output pulse control circuit 77 outputs one pulse of a print timing signal PTS per one pulse of a preliminary timing signal PS. The print timing signal PTS is output to the head driving unit 49 electrically connected to the output pulse control circuit 77.

The head driving unit 49 generates three kinds of discharge waveform pulse by an internal driving signal generation circuit. The head driving unit 49 selects at least one predetermined pulse according a gradation value from the three kinds of discharge waveform pulses based on input gradation data and applies the selected discharge waveform pulse to each piezoelectric element in the recording head 23 at a timing based on the print timing signal PTS. As a result, the discharge waveform pulse (driving voltage) is applied to a piezoelectric element corresponding to a nozzle striking a pixel having a value other than a non-ejection value in the gradation data among the piezoelectric elements and an ink droplet is ejected from the nozzle corresponding to the piezoelectric element. In the present embodiment, in the print timing signal generation circuit 48, the circuit units having the configuration shown in FIG. 4 is provided in each recording head 23 such that print timing of each recording head 23 is set.

FIGS. 5A and 5B show an adjustment chart for adjusting print timing (ejection timing) of each recording head. The adjustment chart includes a pattern group printed in order to acquire an adjustment value for adjusting ejection timing of each recording head, in order to correct a deviation in the subpixels due to a variation in the assembling position of the recording head.

If the print positions of a plurality of subpixels configuring a print pixel (recording pixel) are slightly deviated due to a variation in the assembling positions of the recording heads A and B, the adjustment chart CT shown in FIGS. 5A and 5B is printed and a numerical value (adjustment value) corresponding to an optimal set of patterns PG among a plurality of sets of patterns PG respectively configuring adjustment patterns CT1 and CT2 is input to the printer 11 by operating the operation unit 53. This numerical value corresponds to the number of delay pulses from a reference pulse and a delay value corresponding to an input numerical value is set.

Print of the adjustment chart CT is performed by the instruction unit 62 in the control unit 45 when a print execution instruction of the adjustment chart is received by the operation of the operation unit 53 by the user or when a print instruction signal from the printer driver PD which receives the print execution instruction of the adjustment chart by the operation of the operation unit of the host device HC is received. When receiving the print execution instruction of the adjustment chart, the instruction unit 62 reads chart print data CP stored in the non-volatile memory 47, sends the print data CP to the image processing unit 44, and instructs the head control unit 63, the carriage control unit 64 and the transport control unit 65 to perform the print operation of the adjustment chart CT based on the chart print data CP. At this time, the image processing unit 44 performs image processing of the received chart print data CP and sends head control data obtained through image processing to the head driving unit 49 via the image buffer 46.

The instruction unit 62 instructs the print timing signal generation circuit 48 to individually control the print timings of the recording heads A and B upon chart print. This instruction is performed by changing the delay setting value Dc set by the delay setting value register 76 in the print timing signal generation circuit 48 shown in FIG. 4, by the instruction unit 62. In the present embodiment, the print timing signal generation circuit 48 having the circuit configuration shown in FIG. 4 is provided in each of the recording heads A and B. The instruction unit 62 individually sets the delay setting value Dc defining the print timing according to each pattern to be printed in the delay setting value register 76 corresponding to each of the recording heads A and B. In addition, a plurality of recording heads 23 such as three or more recording heads are included, the number of print timing signal generation circuits 48 is equal to the number of recording heads.

The instruction unit 62 may set the print timing, that is, the delay setting value Dc, for one pass in which the carriage 21 is moved one time in the main scanning direction. Thus, J-pass print needs to be performed in order to print a plurality of sets (J sets) of patterns by different combinations of deviations of printing times, that is, differences of delay setting values Dc.

In the present embodiment, in order to suppress the number of times (pass number) of scanning of the carriage 21 necessary for chart print as small as possible, a pattern of chart print data CP is considered such that a plurality of sets of patterns can be printed by one scanning (one pass).

That is, in the present embodiment, by both setting of the arrangement position of the pattern of the chart print data CP in the main scanning direction and setting of the print timing (that is, the delay setting value Dc), a plurality of sets (J sets) of patterns having different deviations in print timing are printed.

The adjustment chart CT includes a forward movement adjustment chart CTA and a backward movement adjustment chart CTB (the backward movement adjustment chart is not shown). The forward movement adjustment chart and backward movement adjustment chart are basically the same except that they are opposite to each other in the movement direction of the carriage upon chart print. FIGS. 5A and 5B shows only the adjustment chart CTA at the time of forward movement. As shown in FIGS. 5A and 5B, in the adjustment chart CT, in the present embodiment in which the number of recording heads 23 is two, the forward movement adjustment chart CTA includes adjustment patterns CT1 and CT2 of two lines shown in FIGS. 5A and 5B. The backward movement adjustment chart CTB which is not shown includes the substantially same adjustment patterns CT3 and CT4 (not shown) as the adjustment patterns CT1 and CT2 shown in FIGS. 5A and 5B.

The adjustment pattern CT1 for adequately adjusting the print timing between A1 and B1 lines (nozzle arrays) is shown in FIG. 5A. The adjustment pattern CT2 for adequately adjusting the print timing between A2 and B2 lines (nozzle arrays) is shown in FIG. 5B.

In the present embodiment, the adjustment pattern CT1 shown in FIG. 5A in which the deviations in print timings of the nozzle array A1 of the first line of the recording head A and the nozzle array B1 of the first line of the recording head B shown in FIG. 2 are changed is printed. The adjustment pattern CT2 shown in FIG. 5B in which the deviations in print timings of the nozzle array A2 of the second line of the recording head A and the nozzle array B2 of the second line of the recording head B shown in FIG. 2 are changed is printed.

In the present embodiment, in order to adequately adjust the printing timings between the plurality of nozzle arrays in the same recording head, the A1/B1 line adjustment pattern shown in FIG. 5A and the A2/B2 line adjustment pattern shown in FIG. 5B are printed. Alternatively, only any one of the adjustment patterns of FIG. 5A and the adjustment pattern of FIG. 5B may be printed.

The recording heads A and B of the present embodiment perform four-color print using the nozzle arrays A1, A2, B1 and B2. The nozzle array A1 ejects a yellow (Y) ink, the nozzle array A2 ejects a magenta (M) ink, the nozzle array B1 ejects a cyan (C) ink and the nozzle array B2 ejects a black (K) ink.

Between the recording heads A and B shown in FIG. 2, the recording head A is set as a reference recording head and a plurality of patterns is printed at the same print time with respect to the recording head A which is the reference recording head. The recording head B is set as a relative recording head and patterns in which print timings are deviated to a minus side and a plus side.

In the example of FIGS. 5A and 5B, the adjustment value is changed from “0” to the minus side and the plus side by degrees. More specifically, in the vicinity of the adjustment value “0”, the change amount (“1” in the present example) is small and the change amount (“2” in the present example) is increased as the adjustment value is far away from “0”. As shown in FIGS. 5A and 5B, in the present example, the adjustment value is changed to 13 values of “−10, −8, −6, −4, −2, −1, 0, 1, 2, 4, 6, 8, 10”. That is, the adjustment patterns CT1, CT2, CT3 and CT4 of four lines including N sets (13 sets) of patterns PG are printed.

When the adjustment chart CT shown in the example of FIG. 5A is printed, the pattern in case of the numerical value “2” is a pattern in which a plurality of subpixels can be printed at an optimal position. Three white patterns (reference patterns) recorded by the nozzle array Al of the recording head A and two hatched patterns (relative patterns) recorded by the nozzle array B1 of the recording head B are printed. Two relative patterns are adjacently arranged in gaps between the three reference patterns. This state becomes an optimal print timing condition.

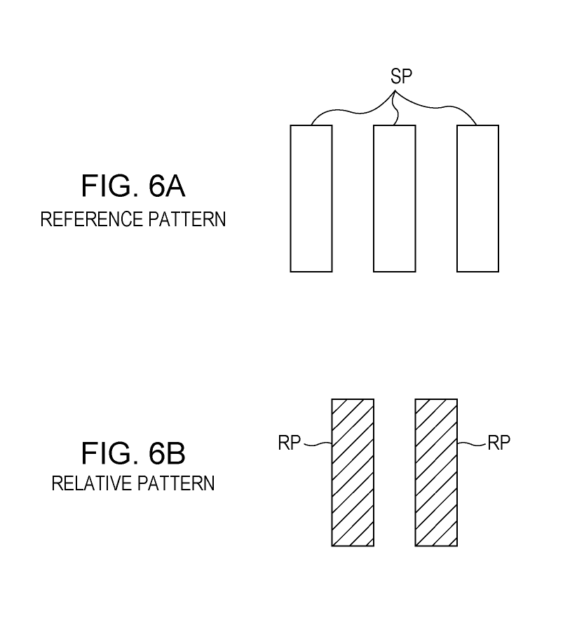

A set of patterns PG is configured by three reference patterns SP shown in FIG. 6A and two relative patterns RP shown in FIG. 6B. The three reference patterns SP are configured by rectangular patterns having the same length and the same width and the gap between the reference patterns SP in the main scanning direction (a horizontal direction of FIGS. 6A and 6B) is equal to the width of the relative patterns RP. The two relative patterns RP are configured by rectangular patterns having the same length and the same width and the gap between the relative patterns RP in the main scanning direction (the horizontal direction of FIGS. 6A and 6B) is equal to the width of the reference patterns SP.

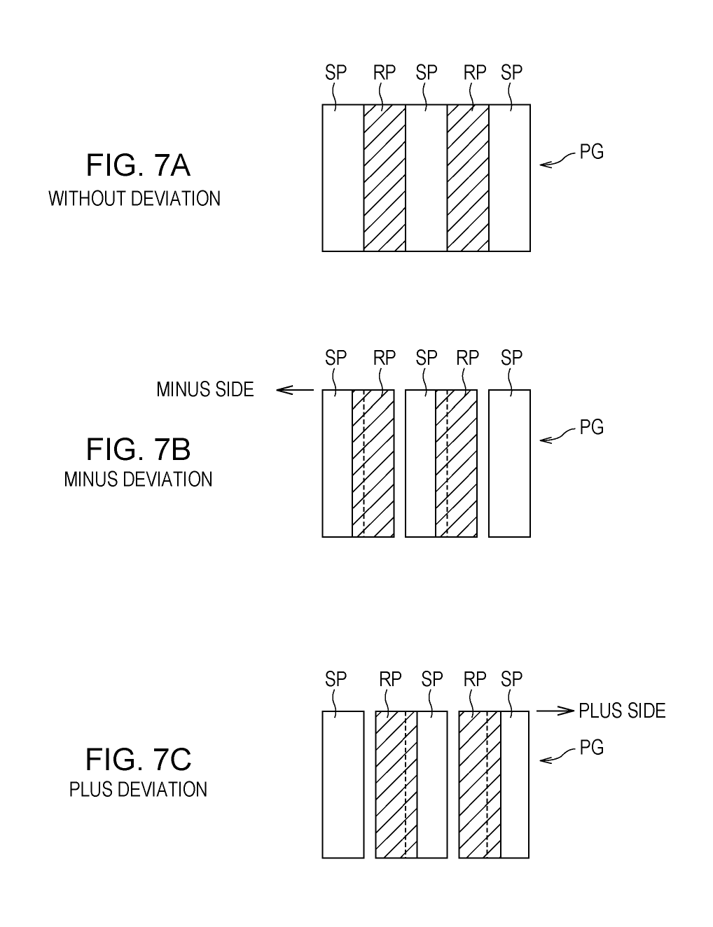

FIGS. 7A to 7C show a relative positional relationship between the reference pattern and the relative pattern, that is, a deviation of the relative pattern from the reference pattern in the main scanning direction. FIG. 7A shows an example without a deviation. In this case, as shown in FIG. 7A, the reference pattern SP and the relative pattern RP are adjacently arranged.

FIG. 7B shows an example in which the relative pattern deviates to the minus side. In this case, as shown in FIG. 7B, by the deviation of the relative pattern RP to the minus side, the relative pattern RP partially overlaps the reference pattern SP adjacent thereto on the left portion (minus side portion) thereof and a gap is generated between the relative pattern and the reference pattern SP adjacent thereto on the right portion (plus side portion).

FIG. 7C shows an example in which the relative pattern deviates to the plus side. In this case, as shown in FIG. 7C, by the deviation of the relative pattern RP to the plus side, a gap is generated between the relative pattern and the reference pattern SP adjacent thereto on the left portion (minus side portion) and the relative pattern RP partially overlaps the reference pattern SP adjacent thereto on the right portion (plus side portion) thereof.

A gap and an overlap portion are generated between the reference pattern SP and the relative pattern RP due to the deviation. Thus, as shown in FIG. 7A, a pattern in which the reference pattern SP and the relative pattern RP are purely adjacently arranged without a gap and an overlap portion therebetween are found and a numerical value (adjustment value) corresponding to the pattern is input.

In the example of the adjustment chart CT (forward movement adjustment chart CTA) shown in FIGS. 5A and 5B, in the A1/B1 line adjustment pattern CT1 of FIG. 5A, the reference pattern SP and the relative pattern RP in case of the adjustment value “2” are adjacently arranged without a gap and overlap portion therebetween and an optimal print timing combination is obtained. That is, by selecting the print timing combination in case of the adjustment value “2”, the deviation in print position (each subpixel print position) due to the variation in the assembling positions of the recording heads A and B in the main scanning direction X is compensated for.

In the A2/B2 line adjustment pattern CT2 of FIG. 5B, the reference pattern SP and the relative pattern RP in case of the adjustment value “2” are adjacently arranged without a gap and overlap portion therebetween and an optimal print timing combination is obtained. That is, by selecting the print timing combination in case of the adjustment value “2”, the deviation in print position due to the variation in the assembling positions of the recording heads A and B in the main scanning direction X is compensated for.

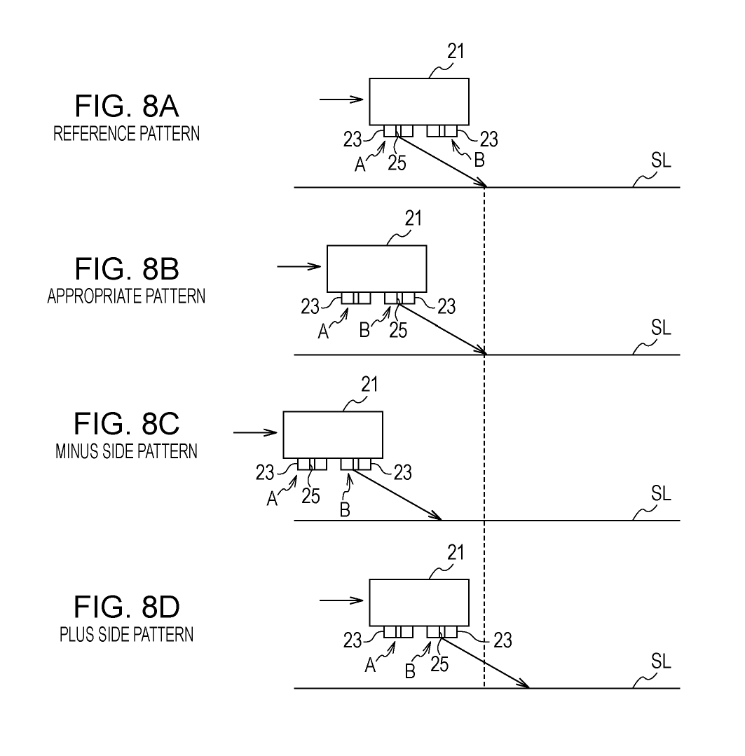

FIGS. 8A to 8D are schematic diagrams illustrating ejection timing of the recording head when printing an adjustment chart. FIG. 8A shows ejection timing when printing a reference pattern SP. A landing position of an ink droplet ejected from the reference recording head A at predetermined ejection timing in FIG. 8A is a reference position of the main scanning direction X. A delay setting value Dc determining the reference ejection timing at this time is Ds (Dc=Ds).

FIGS. 8B to 8C are schematic diagrams when ink droplets are ejected at different ejection timings of the recording head B. FIG. 8B shows ejection timing when printing an adequate pattern. At this time, the ink droplet lands at the reference position. In this case, the pattern PG without a deviation shown in FIG. 7A is printed. Thus, if a delay setting value Dc determining the reference ejection timing at this time is Do (Dc=Do), Dc=Do is an optimal delay setting value of the recording head B.

FIG. 8C shows ejection timing when printing a pattern deviated to the minus side. At this time, the ink droplet lands at a position deviated from the reference position to the minus side. The delay setting value Dc determining the ejection timing at this time is set to be deviated from the delay setting value Do to the minus side (Dc=Do−d)(here, d is a deviation). In this case, the pattern PG deviated to the minus side shown in FIG. 7B is printed.

FIG. 8D shows ejection timing when printing a pattern deviated to the plus side. At this time, the ink droplet lands at a position deviated from the reference position to the plus side. The delay setting value Dc determining the ejection timing at this time is set to be deviated from the delay setting value Do to the plus side (Dc=Do+d). In this case, the pattern PG deviated to the plus side shown in FIG. 7C is printed.

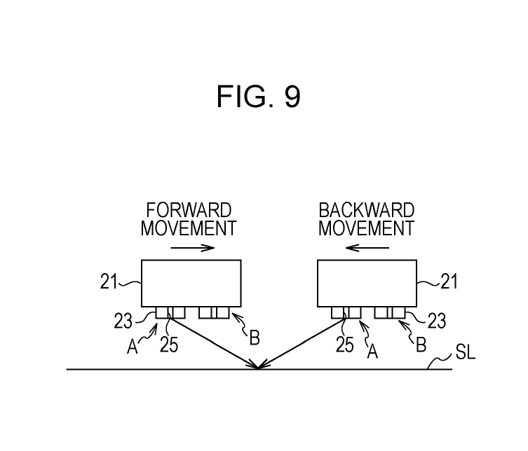

FIG. 9 illustrates a method of adjusting ejection timing upon forward movement and backward movement in bidirectional print (Bi-d print) in which print is performed upon both forward movement and backward movement of the carriage 21. In order to ensure high print quality upon bidirectional print, a landing position of a forward movement process and a landing position of a backward movement process need to coincide. Thus, a pattern in which ejection timing of the forward movement process, that is, the delay setting value Dc, is changed is printed and a pattern in which ejection timing of the backward movement process, that is, the delay setting value Dc, is changed is printed. A combination of patterns with an optimal positional relationship in the main scanning direction between the pattern printed in the forward movement process and the pattern printed in the backward movement process is found and a numerical value corresponding to the pattern is input. As shown in FIG. 9, setting (setting of Bi-d adjustment value) of ejection timings of the forward movement process and the backward movement process upon bidirectional print is performed using the reference recording head A. As shown in FIG. 9, the Bi-d adjustment value in which the landing positions (subpixels) of the forward movement process and the backward movement process of the carriage 21 coincide is set. Alternatively, the bidirectional print setting pattern may be printed using the relative recording head B so as to set the Bi-d adjustment value.

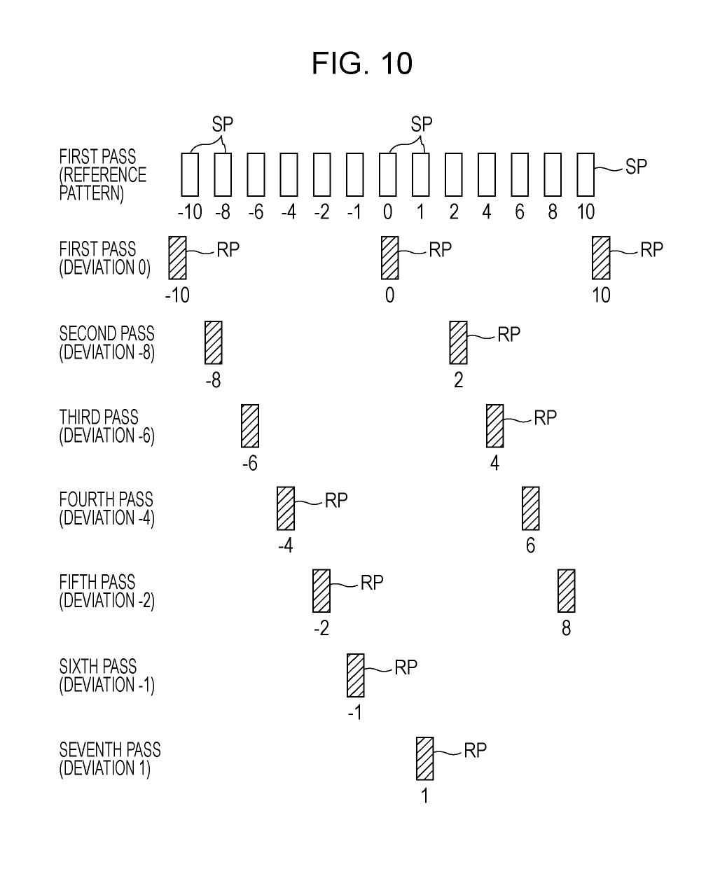

FIG. 10 illustrates the configuration of chart print data used when printing the adjustment chart CT in each scanning (pass) of the carriage 21. In FIG. 10, three reference patterns are schematically represented by one rectangular pattern and two relative patterns are schematically represented by one rectangular pattern. In the present embodiment, one ejection timing (that is, delay setting value Dc) may be set in one pass. Thus, for example, when an adjustment pattern is printed at J sets of different ejection timings, if the ejection timing is switched at every pass, J passes of print operations are performed in order to print one adjustment pattern CT1 (or CT2). Additionally, if two recording heads A and B are included as in the present embodiment, since the adjustment pattern is individually printed in forward movement and backward movement, adjustment patterns of a total of four lines need to be printed and, in this case, 4·J passes of print operations need to be performed.

Thus, in the present embodiment, in order to reduce the number of passes necessary for chart print, by researching the arrangement position (print position) of the pattern in the chart print data CP (image data) in addition to the change of the ejection timing, the number of passes of the carriage 21 necessary to print the adjustment pattern is reduced.

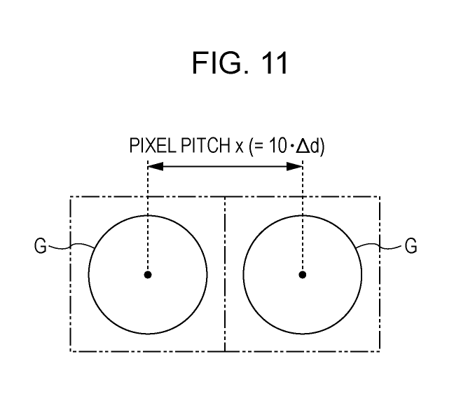

FIG. 11 shows a print pixel. When a minimum unit of the delay setting value Dc is Ad, the pitch (pixel pitch) x between adjacent pixels G in the main scanning direction X is, for example, x=10·Δd. In this case, if the print position of the relative pattern deviates to the minus direction by one pixel pitch x (=10·Δd), even when print is performed at ejection timing of the delay setting value Dc=Do (deviation 0), the print result becomes sequentially equal to the print position when print is performed at ejection timing of the delay setting value of Dc=−10. That is, if a relative pattern, the print position of which deviates to the minus direction by one pixel pitch x (=10·Δd), a relative pattern, the print position of which is not deviated, and a relative pattern, the print position of which deviates to the plus direction by one pixel pitch x (=10·Δd) are printed by one main scanning operation with the delay setting value D=Do (deviation 0), relative patterns RP of delay adjustment amounts “−10”, “0” and “10” may be printed by one pass.

In addition, the relative pattern, the print position of which is not deviated, and the relative pattern, the print position of which deviates to the plus direction by one pixel pitch x (=10·Δd) are printed by one main scanning operation at the delay setting value Dc=Do−8·Δd (deviation −8), the relative pattern RP of delay adjustment amounts “−8” and “2” may be printed by one pass.

In addition, the relative pattern, the print position of which is not deviated, and the relative pattern, the print position of which deviates to the plus direction by one pixel pitch x (=10·Δd) are printed by one main scanning operation at the delay setting value Dc=Do−6·Δd (deviation −6), the relative pattern RP of delay adjustments “−6” and “4” may be printed by one pass.

In this way, by deviation of the arrangement position (print position) of the pattern by one pixel pitch in the main scanning direction, it is possible to print two or more relative patterns RP with substantially different deviation in the ejection timings by the same pass.

In the example of FIG. 10, in a first pass, the reference pattern SP is printed at the predetermined delay setting value Dc=Ds using the recording head A and the relative patterns RP of “−10”, “0” and “10” are printed using the recording head B. In a second pass, the relative patterns RP of “−8” and “2” are printed. In a third pass, the relative patterns RP of “−6” and “4” are printed. In a fourth pass, the relative patterns RP of “−4” and “6” are printed. In a fifth pass, the relative patterns RP of “−2” and “8” are printed. In a sixth pass, the relative pattern RP of “−1” is printed. In a seventh pass, the relative pattern RP of “1” is printed.

If J sets (J=13 in the example of FIGS. 5A and 5B and 10) of patterns PG with different deviations in ejection timing are printed, 13 passes of print operations are necessary if only the ejection timing switching method of each pass is used, but one adjustment pattern CT1 may be printed by seven passes of print operations which are about half thereof. Thus, in the case of printing adjustment patterns CT1 to CT4 of four lines configuring the adjustment chart CT, 52 passes of print operations are necessary if only the ejection timing switching method is used, but only 28 passes of print operations which are half thereof are necessary. The deviation of the print position in the main scanning direction X per “1” change of the delay setting value Dc depends on a carriage speed.

The ejection timing adjustment operation is, for example, set in process examination of a printer manufacturing process. Alternatively, the ejection timing adjustment operation is performed as an initial process when a printer first starts up after a user purchases the printer or as maintenance periodically performed by the user.

In the recording head 23, a discharge driving element is included in each nozzle, a voltage of a predetermined driving waveform is applied to the discharge driving element when a dot value of print image data is, for example, “1” such that ink droplets are discharged from nozzles 19a, and a voltage is not applied to the discharge driving element when a dot value of print image data is, for example, “0” such that ink droplets are not discharged from the nozzles. As the discharge driving element, a heater for heating an ink and discharging ink droplets from the nozzles using pressure of air bubbles by film boiling, etc. may be used in addition to a piezoelectric driving element (piezo element) and an electrostatic driving element.

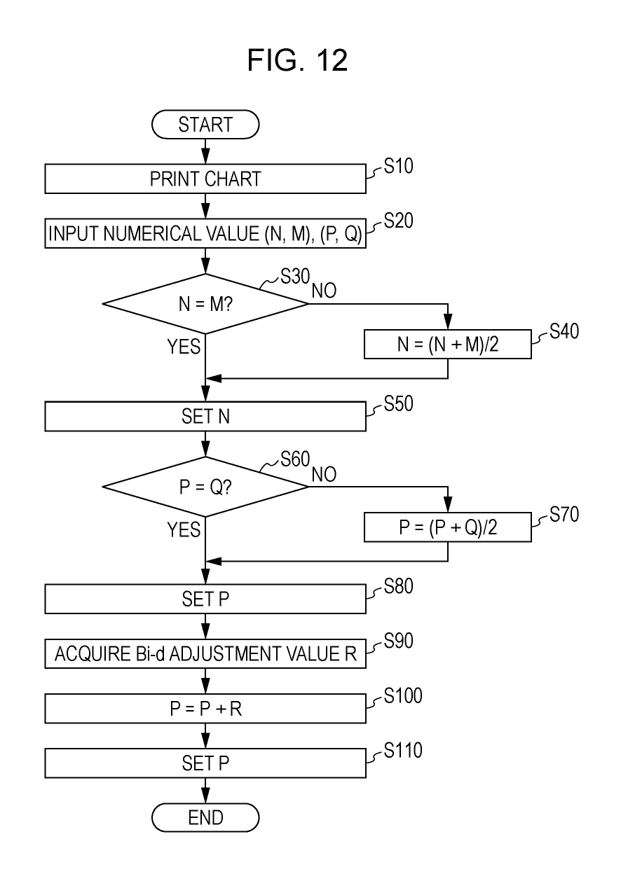

Next, a process will be described with reference to the flowchart of FIG. 12. This process is performed by the control unit 45 of the controller 40. A user operates the operation unit 53, selects a head adjustment function from among adjustment items of a menu displayed on a screen (not shown), and instructs the execution of the head adjustment function. The control unit 45 executes the adjustment process shown in the flowchart of FIG. 12 when an instruction signal instructing the execution of the head adjustment process based on the instruction operation input.

First, in step S10, a chart (adjustment chart) is printed. That is, a forward movement adjustment chart CTA shown in FIGS. 5A and 5B and a backward movement adjustment chart CTB (not shown) are printed. In the present embodiment, the process of step S10 corresponds to a recording step.

In next step S20, adjustment patterns CT1, CT2, CT3 and CT4 of four lines configuring the adjustment chart CT are observed, one set of patterns PG in which a reference pattern SP and a relative pattern RP are best matched with each other (adjacent to each other) is selected therefrom, and numerical values (N, M), (P, Q) corresponding to the selected patterns PG are input. The numerical number (N, M) indicates a combination of a numerical value N corresponding to a pattern PG in which nozzle arrays A1 and B1 are best matched with each other upon forward movement and a numerical value M corresponding to a pattern PG in which nozzle arrays A2 and B2 are best matched with each other upon backward movement. The numerical number (P, Q) indicates a combination of a numerical value P corresponding to a pattern PG in which nozzle arrays A1 and B1 are best matched with each other upon backward movement and a numerical value Q corresponding to a pattern PG in which nozzle arrays A2 and B2 are best matched with each other upon forward movement. For example, in the example of the chart CT of FIGS. 5A and 5B, the patterns of the numerical value of “2” are best matched with each other in the adjustment pattern CT1 of the A1/B1 array of the forward movement adjustment chart CTA and the patterns of the numerical value of “2” are best matched with each other in the adjustment pattern CT2 of the A2/B2 array. Thus, the user operates the operation unit 53 so as to input (2, 2) as (N, M) such that (N, M)=(2, 2) is input. Therefore, the control unit 45 inputs the numerical values (N, M), (P, Q).

In step S30, a determination as to whether N=M is made. If N=M, “N” is set as the forward movement adjustment value in step S50. In contrast, if N≠M, N=(N+M)/2 is computed in step S40 and the computed value N (=(N+M)/2) is set as the forward movement adjustment value in step S50. That is, in case of N=M, since the optimal adjustment values in the A1/B1 array adjustment pattern CT1 and the A2/B2 array adjustment pattern CT2 are equal (N=M), the value N is as the forward movement adjustment value. In case of N≠M, since the optimal adjustment values in the A1/B1 array adjustment pattern CT1 and the A2/B2 array adjustment pattern CT2 are different (N≠M), the average (=(N+M)/2) of the adjustment values N and M is set as the forward movement adjustment value.

Steps S60 to S80 perform a process of setting backward movement adjustment values, similar to the process of setting the forward movement adjustment values of steps S30 to S50.

In step S60, a determination as to whether P=Q is made. If P=Q, “P” is set as the backward movement adjustment value in step S80. In contrast, if P≠Q, P=(P+Q)/2 is computed in step S70 and the computed value P (=(P+Q)/2) is set as the backward movement adjustment value in step S80. That is, in case of P=Q, since the optimal adjustment values in the A1/B1 array adjustment pattern CT3 and the A2/B2 array adjustment pattern CT4 are equal (P=Q), the value P is set as the backward movement adjustment value. In case of P≠Q, since the optimal adjustment values in the A1/B1 array adjustment pattern CT3 and the A2/B2 array adjustment pattern CT4 are different (P≠Q), the average (=(P+Q)/2) of the adjustment values P and Q is set as the backward movement adjustment value.

In next step S90, a Bi-d adjustment value R is acquired. For example, the predetermined Bi-d adjustment value R is read from the non-volatile memory 47. In the Bi-d adjustment value R, as shown in FIG. 9, using the nozzle array A1 as an example of the recording head A, a pattern with lowest deviation is selected from Bi-d adjustment patterns printed by changing a combination of delay values (that is, deviation which is a difference between combinations of delay values) upon forward movement and backward movement and an adjustment value R corresponding to the selected pattern is set.

In step S100, an adjustment value P=P+R is computed. That is, the adjustment value P obtained by adding the Bi-d adjustment value R to the forward movement adjustment value P is computed. In step S110, this adjustment value P is set. In this way, the forward movement adjustment value N and the backward adjustment value P are respectively set and the adjustment values N and P are stored in a predetermined storage region of the non-volatile memory 47. In the present embodiment, the process of steps S20 to S110 corresponds to an adjustment step.

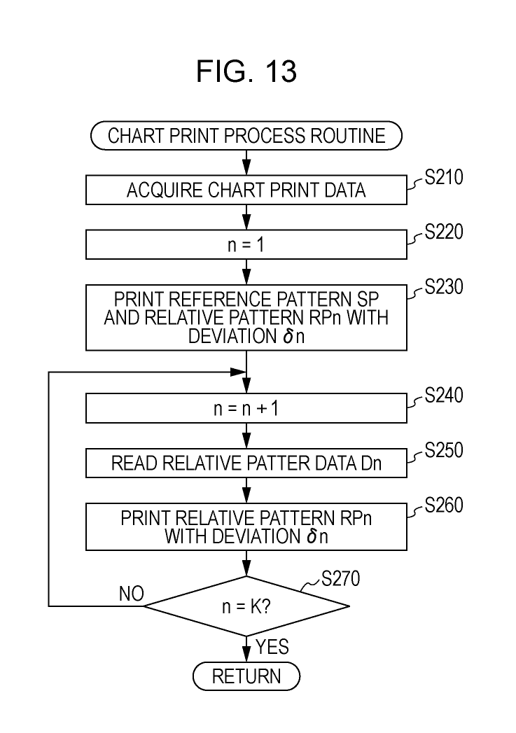

In the present embodiment, the print of the chart of step S10 is performed by executing a chart print process routine illustrated in the flowchart of FIG. 13 by the control unit 45. Hereinafter, the content of the chart print process will be described with reference to FIG. 13. The flowchart of FIG. 13 shows the processing content for printing an adjustment content of one line. If the adjustment chart CT configured by adjustment patterns of four lines is printed, the process of the flowchart of FIG. 13 is performed with respect to four lines (four times). When the adjustment patterns CT1 and CT2 are printed, ink droplets are ejected from the nozzles of the recording heads A and B in the process of moving the carriage 21 forward and, when the adjustment patterns CT3 and CT4 are printed, ink droplets are ejected from the nozzles of the recording heads A and B in the carriage 21 backward.

In step S210, chart print data is read and acquired from the non-volatile memory 47. The chart print data is image data including a reference pattern of one line and a relative pattern having a deviation δn (n=1, 2, . . . , K).

In next step S220, n=1 is set. Here, n is a count value of a counter and is used to determine the deviation δn of the pattern. Here, n is set as an initial value (n=1). In the present example, n corresponds to the number of passes when the adjustment pattern is printed.

In step S230, the reference pattern and the relative pattern Pn (=P1) with the deviation δn (=δ1) are printed. At this time, reference pattern data Dst and relative pattern data Dn (=D1) are read, the reference pattern SP is printed using the nozzle array A1 of the recording head A based on the data Dst, and the relative pattern RP is printed using the nozzle array B1 of the recording head B based on data Dn (=D1). That is, print of a first pass is performed and the reference pattern SP and the relative pattern RP with the deviation δ1 (for example, “deviation 0”) shown in FIG. 10 are printed. In this case, as shown in FIG. 10, three patterns RP of deviations “−10, 0, 10” are printed.

In step S240, n=n+1 is set. That is, n increases by “1” (n=2).

In step S250, the relative pattern data Dn is read.

In step S260, the relative pattern RPn is printed with the deviation 8n. That is, print of a second pass is performed and the relative pattern RP with the deviation 82 (for example, “deviation −8”) shown in FIG. 10 is performed. In this case, as shown in FIG. 10, two patterns RP with the deviations “−8, 2” are printed.

In step S270, a determination as to whether n=K is made. Here, K is a value corresponding to the number of passes necessary to print the adjustment pattern and a determination as to whether or not print of the adjustment pattern is finished is made depending on whether n=K. If n≠K, since patterns to be printed remain, the method returns to step S240.

In this way, a determination as to whether print is finished is made whenever print of one pass is performed, n increases if patterns to be printed remain, the relative pattern data Dn is read according to the n value, and the relative pattern data RPn with the deviation 8n is printed based on the data Dn. This is repeated in each pass until n=K.

As the result of the process (S240 to S270), as shown in FIG. 10, two patterns RP with the deviations “−6, 4” are printed by print of a third pass. Two patterns RP with the deviations “−4, 6” are printed by print of a fourth pass. Two patterns RP with the deviations “−2, 8” are printed by print of a fifth pass. One pattern RP with the deviations “−1” is printed by print of a sixth pass. Further, one pattern RP with the deviations “1” is printed by print of a seventh pass. If the print of the seventh pass is finished, n=K (n=7, in the present example) is satisfied and the process is finished. As the result of this process, for example, the adjustment pattern CT1 shown in FIG. 5A is printed. In addition, the routine of FIG. 13 is executed and the adjustment pattern CT2 shown in FIG. 5B is printed. The process is switched to print upon backward movement, the routine of FIG. 13 is executed one time to print the adjustment pattern CT3, and the routine of FIG. 13 is executed one more time to print the adjustment pattern CT4.

In addition, in the case where one optimal set of patterns PG largely deviates from, for example, the deviation “0” and has a deviation of “6” or “−6”, an adjustment value is computed and set based on a numerical value according to the deviation, an adjustment chart is printed again based on the adjustment value, and a numerical value according to one optimal set of patterns PG is input. This operation is repeatedly performed until one optimal set of patterns PG satisfying the condition in which the deviation is in a predetermined range (for example, equal to or greater than −2 and equal to or less than 2) is selected.

In the case where the numerical value corresponding to one optimal set of patterns PG selected as the A1/B1 array adjustment pattern CT1 and the numerical value corresponding to one optimal set of patterns PG selected as the A2/B2 array adjustment pattern CT2 deviate, it indicates that the gap between the plurality of nozzle arrays formed in the same recording head in the main scanning direction X differ between the plurality of recording heads 23. Accordingly, in this case, notification of error is made. Since the printer 11 is examined before shipment, it is basically hard for such error to occur.

The adjustment values N and P acquired in this way are stored in the non-volatile memory 47 as a part of adjustment data TD. The adjustment values N and P are correction values for a default delay setting value Dc. If print is performed after adjustment, the instruction unit 62 reads the adjustment value from the non-volatile memory 47 and adds the adjustment value to the default value of the delay setting value Dc as correction.

As described above in detail, according to the present embodiment, the following effects can be obtained.

(1) The instruction unit 62 individually adjusts the ejection timings of the plurality of recording heads A and B and instructs a plurality of sets of ejection timings with different deviations in the ejection timings between the plurality of recording heads A and B. The head control unit 63 and the carriage control unit 64 configuring the recording execution unit perform recording of the plurality of recording heads A and B at a plurality of sets of ejection timings instructed by the instruction unit 62. As a result, adjustment patterns including a plurality of sets of patterns PG according to the plurality of sets of ejection timings are printed on a sheet SL (recording medium). The adjustment unit 61 receives the numerical value corresponding to one optimal set of patterns PG among the plurality of sets of patterns PG, and sets the adjustment value computed based on the numerical value so as to set ejection timings. Therefore, it is possible to relatively simply suppress a variation in recording position due to the variation in position of the relative movement direction of the plurality of recording heads A and B. Accordingly, it is possible to suppress deterioration in print quality due to the variation in positions of the recording heads A and B.

(2) In the serial type printer 11, it is possible to set an adequate adjustment value in consideration of the deviation in the assembling position of the main scanning direction X (relative movement direction) of the plurality of recording heads A and B individually assembled in the carriage 21.

(3) The instruction unit 62 instructs the deviations of the ejection timings of the other recording heads relative to the ejection timing of one recording head to become different by degrees. Since the ejection timing of one recording head is constantly set and the ejection timings of the other recording heads deviate by different deviations by degrees, the instruction of the instruction unit 62 is relatively simple.

(4) A plurality of sets of patterns in which patterns printed by one recording head of the plurality of recording heads A and B and the patterns printed by another recording head are adjacently arranged in the relative movement direction is recorded. Accordingly, it is easy to determine one optimal set of patterns PG among the plurality of sets of patterns PG. As a result, it is possible to set an optimal adjustment value determining optimal recording timing.

(5) The configuration in which the user inputs the input value corresponding to one optimal set of patterns of the plurality of sets of patterns PG by the operation of the operation unit 53 was employed. The adjustment unit 61 sets the adjustment value determining the optimal ejection timings of the plurality of recording heads A and B based on the input value received by the operation of the operation unit 53. Since the adjustment value determining the ejection timing corresponding to one optimal set of patterns PG determined by the user is set, it is possible to obtain the print quality desired by the user. In addition, it is possible to provide an ejection timing adjustment device having a relatively simple configuration without performing a relative complicated process such as image analysis.

(6) The carriage 21 passes one time at ejection timing of one deviation, the deviation differs between passes, a plurality of passes of carriage movement is performed, and a plurality of sets of patterns is printed. At this time, by using chart print data (image data) in which the print position of the pattern deviates in pixel pitch units of the print pixel in the main scanning direction X, it is possible to print a plurality of sets of patterns with different deviations in ejection timings in one pass. Accordingly, the number of passes of the carriage 21 necessary to print the adjustment chart CT is relatively small and thus the adjustment chart CT can be printed in a relatively short period of time.

(7) Recording of the forward movement process and recording of the backward movement process are separately performed by the plurality of recording heads A and B so as to print the forward movement adjustment chart CTA and the backward movement adjustment chart CTB. From the adjustment charts CTA and CTB, the forward movement adjustment value and the backward movement adjustment value are set. Accordingly, it is possible to individually set the adequate ejection timing in both directions of the forward movement process and the backward movement process of the plurality of recording heads A and B. Thus, even when at least one of the plurality of recording heads A and B is assembled such that a nozzle opening surface is inclined from a horizontal plane, it is possible to set adequate ejection timing considering this inclination.

(8) The deviation between the ejection timing of the forward movement process and the ejection timing of the backward movement process of one recording head A of the plurality of recording heads A and B is changed by degrees, such that print (second recording) of the Bi-d adjustment chart is performed. The adjustment unit 61 sets the adjustment values N and P determining the ejection timings of the plurality of recording heads A and B based on the Bi-d adjustment value R and the adjustment values N and P. Accordingly, it is possible to set the adequate adjustment values N and P considering the Bi-d adjustment value R.

### SECOND EMBODIMENT

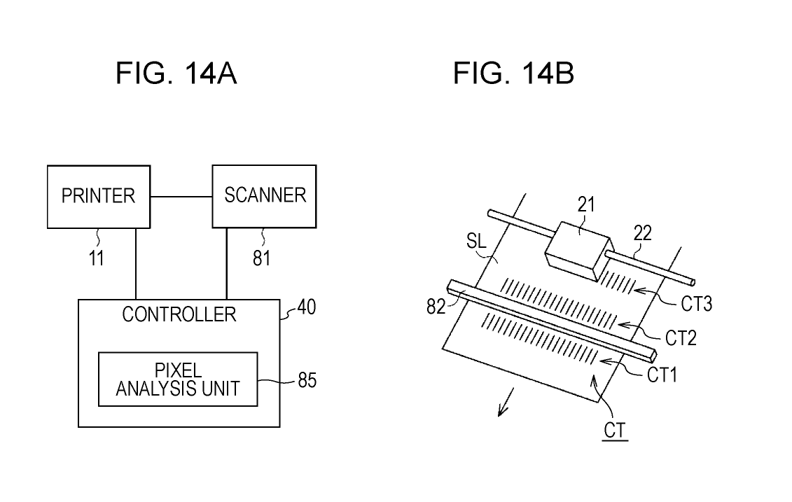

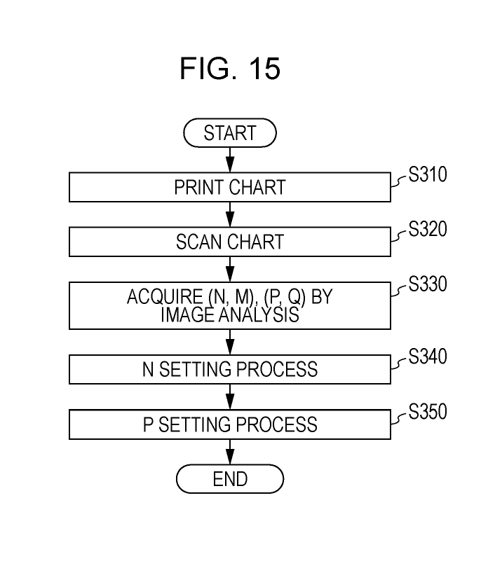

Next, a second embodiment will be described with reference to FIGS. 14 and 15.

This embodiment is different from the first embodiment in that an optimal adjustment value is automatically set by reading a print image of a chart and performing image analysis.

As shown in FIG. 14A, a scanner 81 is connected to the printer 11 as an example of a reading unit. For example, there are a configuration in which the scanner 81 is connected to the printer 11 as a separate device or a configuration of a multifunctional machine in which the scanner 81 is integrally provided with the printer 11.

As the other configuration, as shown in FIG. 14B, a configuration in which an image sensor 82 is provided at the transport-direction downstream side of the traveling area of the carriage 21 as an example of reading unit having a length for reading a print surface of the sheet SL over the entire width direction of the sheet SL may be employed. In the image sensor 82, for example, a plurality of CCD elements is arranged along a sheet width direction. In a process of moving the carriage 21 in the main scanning direction, a configuration for reading a pattern printed on the sheet SL by the image sensor mounted in the carriage 21 may be employed.

Chart image data obtained by reading the adjustment chart CT (the plurality of adjustment patterns CT1 to CT4) printed on the sheet SL by the scanner 81 or the image sensor 82 is stored in the reception buffer 42 of the controller 40. An image analysis unit 85 which is an example of image analysis unit is included in the control unit 45 provided in the controller 40 and the image analysis unit 85 analyzes the image of the chart image data read from the reception buffer 42 in each of the adjustment patterns CT1 to CT4. As the result of image analysis, one set of patterns PG in which the reference pattern SP and the relative pattern RP are best matched with each other (adjacent to each other) is specified and an adjustment value corresponding to the specified set of pattern PG is acquired.

FIG. 15 is a flowchart illustrating this adjustment process.

First, in step S310, the chart CT is printed. In step S320, the chart CT is scanned. In step S330, (N, M), (P, Q) are acquired by image analysis. In step S340, an N setting process is performed. This N setting process corresponds to the process of S30 to S50 of FIG. 12.

In step S350, a P setting process is performed. This P setting process corresponds to the process of S600 to S110 of FIG. 12. That is, in this P setting process, the adjustment value P is set by adding the Bi-d adjustment value R to the P value obtained by image analysis of the chart CT. By setting the adjustment values N and P, optimal print timings of the plurality of recording heads A and B are set. In addition, S310 corresponds to a recording step and S320 to S350 correspond to an adjustment step.

According to the second embodiment, an image analysis process is performed with respect to the image data obtained by reading the chart CT by the scanner 81 or the image sensor 82 and one optimal set of pattern PG is specified from the image analysis result. The adjustment value corresponding to the specified set of pattern PG is set. Accordingly, it is possible to automatically set optimal print timings of the plurality of recording heads 23.

### THIRD EMBODIMENT

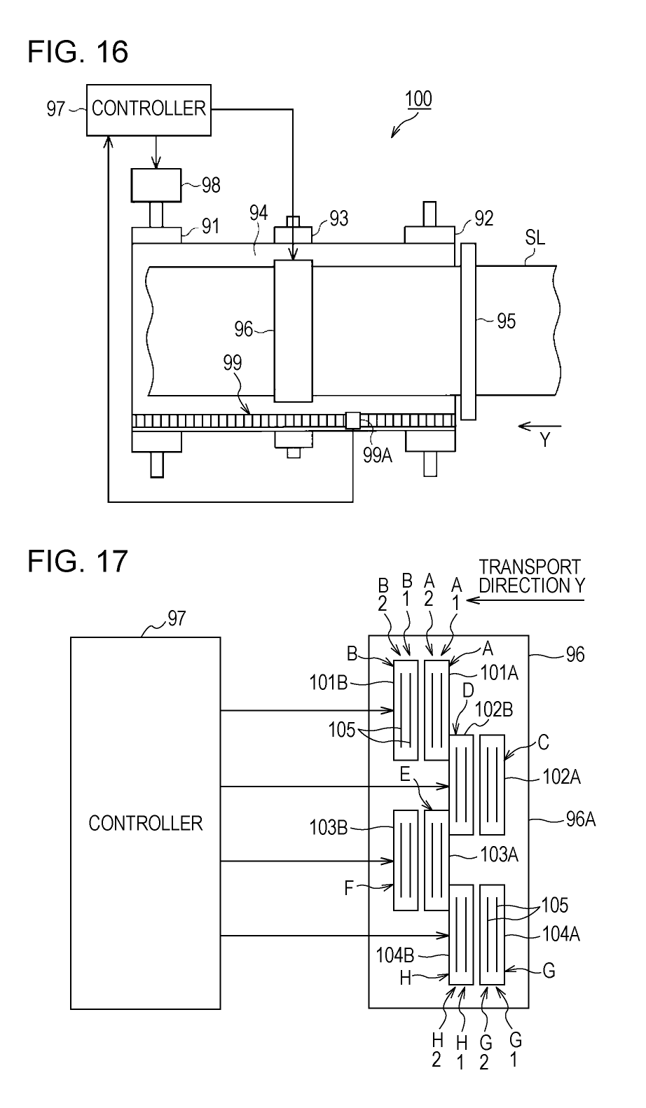

Next, a third embodiment of an ink jet recording type line printer which is an example of a recording apparatus will be described with reference to FIGS. 16 and 17.

FIG. 16 is a schematic plan view of a line printer. As shown in FIG. 16, in the line printer 100, a sheet SL is transported onto a transport belt 94 wound on a plurality of rollers 91 to 93 through a roller 95. A recording unit 96 is arranged at the appropriately central portion of the transport direction of the transport belt 94 at a position from the belt surface to the upper side (the front side of the orthogonal direction of the paper in FIG. 16) with a gap interposed therebetween. The recording unit 96 is a so-called multi-head type recording unit in which a plurality of recording heads #1 to #n (see FIG. 17) is arranged over an entire maximum sheet width. A controller 97 shown in FIG. 16 drives a transport motor 98 such that the sheet SL is transported on the transport belt 94 to the downstream side (the left side of FIG. 16) of the transport direction Y at a constant speed and ink droplets are ejected from the recording heads 101A to 104A and 101B to 104B (see FIG. 17) of the recording unit 96 to the sheet SL, thereby printing of the sheet SL. In addition, a linear encoder 99 is provided on the edge of the transport belt 94 such that the ejection timings of the recording heads 101A to 104A and 101B to 104B are controlled by the controller 97 based on discharge timing signal generated from the encoder pulse output from the sensor 99A of the linear encoder 99.

FIG. 17 shows the bottom of the recording unit and the controller of the line printer 100. In the line printer 100, as shown in FIG. 17, on the bottom of the main body 96A of the recording unit 96, a plurality (8 in the present example) of recording heads 101A to 104A and 101B to 104B is provided. As the recording heads 101A to 104A and 101B to 104B, a total of four sets each including two heads adjacently arranged in the transport direction Y is arranged in a zigzag shape. The recording heads 101A to 104A and 101B to 104B are electrically connected to the controller 97 and the ejection thereof is controlled by the controller 97. The controller 97 is basically equal to the controller 40 of the first embodiment.

In the set, the recording heads 101A to 104A located on the upstream side of the transport direction have two nozzle arrays 105 corresponding to the ink colors (K, C) in the nozzle opening surfaces thereof and the recording heads 101B to 104B located on the downstream side of the transport direction have two nozzle arrays 105 corresponding to the ink colors (M, Y) in the nozzle opening surfaces thereof.

In the line printer 100, the recording heads 101A and 101B, 102A and 102B, 103A and 103B, and 104A and 104B for printing a plurality of subpixels configuring the print pixel on the transported sheet SL are arranged at different positions of the transport direction Y. As shown in FIG. 17, eight recording heads are respectively referred to as recording heads A to H and the respective nozzle arrays are referred to as nozzle arrays A1, A2, B1, B2, C1, C2, D1, D2, . . . , G1, G2, H1, and H2. In this case, similarly to the first embodiment, the A1/B1 array adjustment pattern, the C1/D1 array adjustment pattern, the E1/F1 array adjustment pattern, the G1/H1 array adjustment patter, etc. are printed. Even in this line printer 100, the adjustment chart CT is printed, a numerical value corresponding to an optimal pattern PG is acquired as an input value based on the operation of the operation unit or is acquired from an image analysis result of a read image of a reading unit such as a scanner or an image sensor. The adjustment unit 61 performs predetermined computation based on the acquired numerical value, obtains an adjustment value, and setting the obtained adjustment value, thereby setting the adequate ejection timing of each recording head.

The above embodiments may be changed to the following aspects.

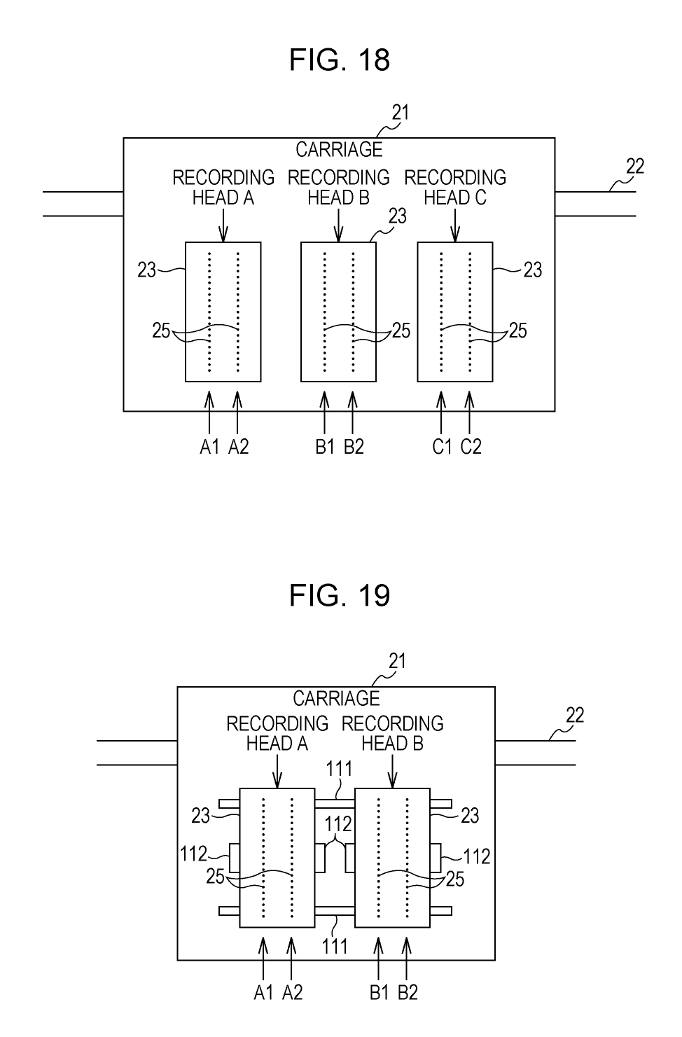

The number of recording heads is not limited to two and, as shown in FIG. 18, three recording heads A, B and C 23 may be arranged along the main scanning direction X in the carriage 21. In this example, the A1/B1 array adjustment chart and the A1/C1 array adjustment chart are printed. In addition, the A2/B2 array adjustment chart and the A2/C2 array adjustment chart may be printed.

The present invention is not limited to only the adjustment of the recording timing. The positional relationship between the plurality of recording heads A and B may be adjusted. As shown in FIG. 19, a plurality of recording heads A and B 23 is mounted in the carriage 21 in a state of being guided to a guide rail 111 to be moved in the main scanning direction X. In each of the recording heads A and B, an actuator 112 for individually moving (displacing) each of the recording heads A and B in the main scanning direction X is provided. In the actuator 112, for example, a piezoelectric actuator driven by electrostriction or the like is used. For example, since there is a limit in adjustment using the delay setting value Dc, the actuator 112 is driven to adjust the relative positions of the plurality of recording heads A and B in the main scanning direction X, thereby performing coarse adjustment. After coarse adjustment, as necessary, the adjustment chart CT is printed again and a numerical value corresponding to one optimal set of patterns PG is acquired. The adjustment unit 61 sets an adjustment value computed based on the acquired numerical value as a part of adjustment data TD.

Although print is performed a plurality of sets of ejection timings with different deviation in ejection timing between a plurality of sets of different nozzle arrays (A1/B1 array and A2/B2 array) of the recording heads, a configuration in which an adjustment pattern of a combination of nozzle arrays corresponding in number of recording heads may be employed. For example, in the first embodiment, a configuration for printing only the A1/B1 array adjustment pattern or the A2/B2 array adjustment pattern may be employed.

The A1/B2 array adjustment pattern and the A2/B1 array adjustment pattern may be employed. Only the A1/B2 array adjustment pattern or only the A2/B1 array adjustment pattern may be employed.

In the modified example of FIG. 18, only the A1/B1 array adjustment pattern and the A1/C1 array adjustment pattern may be employed.

The shape and the number of patterns configuring one kind of pattern PG may be appropriately changed. For example, the numbers of reference patterns and relative patterns may be set to be opposite thereto and a combination of two reference patterns and three relative patterns may be employed. In addition, a combination of two reference patterns and one relative pattern or a combination of one reference pattern and two relative patterns may be employed. The numbers of reference patterns and relative patterns may be the same and, for example, one reference pattern and one relative pattern, two reference patterns and two relative patterns, three reference patterns and three relative patterns, etc. may be employed. The width of the pattern may be appropriately changed, the widths of the reference pattern and the relative pattern may be different, the widths of the reference patterns may be different, or the width of the relative patterns may be different. The pattern shape is not limited to a rectangle and may be a triangle, a circle, an ellipse, a polygon such as a pentagon. Alternatively, the shapes of the reference pattern and the relative pattern may be different. If a difference in relative positional relationship between the reference pattern and the relative pattern is identified, the shape and number of patterns may be arbitrarily set.

Although a numerical value (adjustment value) without a gap or overlap between the reference pattern and the relative pattern is selected, a numerical value (adjustment value) corresponding to the gap or overlap may be selected. In addition, if a difference in relative positional relationship between the reference pattern and the relative pattern is identified, the shape and number of patterns may be arbitrarily set.

The number of nozzle arrays per one recording head may be appropriately changed. For example, a configuration in which one nozzle array or three or more nozzle arrays is included in one recording head may be employed.

In the case where the recording head and the recording medium are relatively moved one time (for example, one pass), a configuration in which the recording timing of each recording head may be changed may be employed.

According to this configuration, it is possible to reduce the number of passes necessary to print the adjustment chart.

The recording timing adjustment device is not software by, for example, a CPU, but may be hardware by an integrated circuit such as ASIC. Further, cooperation of software and hardware may be configured.

The recording medium is not limited to an elongated sheet made of paper, resin, or the like and may be a single-paper or slip-like resin film. A metal film, clothes, a film substrate, a resin plate, a semiconductor wafer, or the like may be used. An optical disc such as a CD or a DVD or a storage medium such as a magnetic disc may be used. The recording medium is not limited to the sheet shape and, in case of a recording device having a mechanism for performing printing on a predetermined stereoscopic surface, an object having a predetermined stereoscopic shape is also included.

The recording device is not limited to the ink jet printer 11 and a dot impact type printer, a laser printer, or the like may be used.

Although, in the above-described embodiment, the ink jet printer 11 is implemented as the recording apparatus, a fluid ejecting apparatus for ejecting or discharging other liquids except for the ink may be implemented. The invention is applicable to various types of liquid ejecting apparatuses including a liquid ejecting head for discharging a small amount of liquid droplets. The liquid droplets indicate a liquid state discharged from the liquid ejecting apparatus and include a granular shape, a tear shape, and a thread shape. The term “liquid” described herein may be a material which can be ejected from the liquid ejecting apparatus. For example, the liquid includes a state when the material is a liquid phase; a flow state such as a liquid having high or low viscosity, sol, gel water, an organic solvent, an inorganic solvent, a solution, liquid resin and liquid metal (metallic solution); a liquid as one state of the material; and a material obtained by dissolving, dispersing or mixing the particles of the functional material made of a solid such as pigment or metal particles. As a representative example of the liquid, the ink described in the above-described embodiment or liquid crystal may be used. The ink includes various types of liquid compositions such as an aqueous ink, oil-based ink, a gel ink and a hot-melt ink. The detailed examples of the liquid ejecting apparatus include, for example, a liquid ejecting apparatus for ejecting a liquid including a material, such as an electrode material or a coloring material, used for manufacturing a liquid crystal display, an electroluminescence (EL) display, a field emission display and a color filter in a dispersion or dissolution form; a liquid ejecting apparatus for ejecting a bio organic matter used for manufacturing biochips; a liquid ejecting apparatus for ejecting a liquid which is a sample such as a precision pipette, a printing apparatus and a micro dispenser. In addition, a liquid ejecting apparatus for ejecting lubricating oil to a precision machinery such as clocks or cameras by a pinpoint, a liquid ejecting apparatus for ejecting a transparent resin solution such as ultraviolet curing resin onto a substrate in order to form a minute semispherical lens (optical lens) used for an optical communication element, and a liquid ejecting apparatus for ejecting an etchant such as acid or alkali in order to etch substrates or the like may be employed. The invention is applicable to any one of the above-described liquid ejecting apparatuses. Fluid may be a powder and granular material such as toner. The fluid described in the present specification does not include only gas.

What is claimed is:

1. A recording timing adjustment apparatus of a recording apparatus in which a plurality of recording units record a plurality of subpixels configuring a recording pixel while relatively moving the plurality of recording units and a recording medium so as to perform recording with respect to the recording medium, the recording timing adjustment apparatus comprising:
a relative movement unit that relatively moves the plurality of recording units and the recording medium;
an instruction unit that individually adjusts recording timings of the plurality of recording units and instructs a plurality of sets of recording timings with different deviations in recording timing between the plurality of recording units;
a recording execution unit that enables the plurality of recording units to perform recording at the plurality of sets of recording timings instructed by the instruction unit; and
an adjustment unit that sets one set of recording timings based on plural kinds of recording results according to the plurality of sets of recording timings when the recording execution unit enables the plurality of recording units to perform recording.

2. The recording timing adjustment apparatus according to claim 1, wherein the plurality of recording units is assembled in a carriage moved by the relative movement unit at positions different from the relative movement direction.

3. The recording timing adjustment apparatus according to claim 1, wherein the instruction unit instructs the recording timings of the other recording units to be different from the recording timing of one recording unit by degrees, and
the recording execution unit enables the plurality of recording units to respectively record a pattern.

4. The recording timing adjustment apparatus according to claim 1, wherein the recording execution unit records a plurality of sets of patterns in which a pattern recorded by one of the plurality of recording units and a pattern recorded by another recording unit are adjacently arranged in a relative movement direction.

5. The recording timing adjustment apparatus according to claim 1, wherein the adjustment unit receives an input value corresponding to a recording result of one of the plural kinds of recording results based on an operation of an operation unit and sets the recording timings based on the input value.

6. The recording timing adjustment apparatus according to claim 1, further comprising:
a reading unit that reads the plural kinds of recording results recorded by the plurality of recording units; and
an image analysis unit that analyzes an image read by the reading unit and obtains a recording result with a minimum deviation in the relative movement direction,
wherein the adjustment unit sets the recording timing corresponding to the recording result obtained by the image analysis unit.

7. The recording timing adjustment apparatus according to claim 4, wherein one relative movement is performed at a recording timing of one deviation and a plurality of relative movements is performed with deviations different from the deviation of one relative movement so as to record the plurality of sets of patterns, and
the recording execution unit records the plurality of sets of patterns with different deviations in recording timing in one relative movement based on image data in which a recording position of the pattern deviates in units of pixel pitch of the recording pixel in the relative movement direction.

8. The recording timing adjustment apparatus according to claim 1, wherein the recording execution unit enables the plurality of recording units to perform recording of a forward movement process in the relative movement direction and to perform recording of a backward movement process in the relative movement direction.

9. The recording timing adjustment apparatus according to claim 1, wherein the deviations of the recording timing of the forward movement process and the recording timings of the backward movement process of at least one of the plurality of recording units are changed by degrees so as to perform a second recording, and
the adjustment unit sets the recording timings of the plurality of recording units based on the deviations in the recording timings of the forward movement process and the backward movement process of the recording unit determined based on the second recording result of the second recording and the deviation in the recording timing between the plurality of recording units.

10. A recording apparatus including a plurality of recording units and a relative movement unit that relatively moves the plurality of recording units and a recording medium, comprising the recording timing adjustment apparatus according to claim 1.

11. A recording apparatus including a plurality of recording units and a relative movement unit that relatively moves the plurality of recording units and a recording medium, comprising the recording timing adjustment apparatus according to claim 2.

12. A recording apparatus including a plurality of recording units and a relative movement unit that relatively moves the plurality of recording units and a recording medium, comprising the recording timing adjustment apparatus according to claim 3.

13. A recording apparatus including a plurality of recording units and a relative movement unit that relatively moves the plurality of recording units and a recording medium, comprising the recording timing adjustment apparatus according to claim 4.

14. A recording apparatus including a plurality of recording units and a relative movement unit that relatively moves the plurality of recording units and a recording medium, comprising the recording timing adjustment apparatus according to claim 5.

15. A recording apparatus including a plurality of recording units and a relative movement unit that relatively moves the plurality of recording units and a recording medium, comprising the recording timing adjustment apparatus according to claim 6.

16. A recording apparatus including a plurality of recording units and a relative movement unit that relatively moves the plurality of recording units and a recording medium, comprising the recording timing adjustment apparatus according to claim 7.

17. A recording apparatus including a plurality of recording units and a relative movement unit that relatively moves the plurality of recording units and a recording medium, comprising the recording timing adjustment apparatus according to claim 8.

18. A recording apparatus including a plurality of recording units and a relative movement unit that relatively moves the plurality of recording units and a recording medium, comprising the recording timing adjustment apparatus according to claim 9.

19. A recording timing adjustment method of a recording apparatus in which a plurality of recording units records a plurality of subpixels configuring a recording pixel while relatively moving the plurality of recording units and a recording medium so as to perform recording with respect to the recording medium, the recording timing adjustment method comprising:
relatively moving the plurality of recording units and the recording medium and performing recording at a plurality of sets of recording timings with different deviations in recording timing between the plurality of recording units; and
setting one set of recording timings based on plural kinds of recording results obtained as the result of recording.
